(19) United States
(12) Patent Application Publication
(10) Pub. No.: US 2013/0164984 A1
(43) Pub. Date: Jun. 27, 2013

(54) DISPLAY HAVING ILLUMINATION FUNCTION AND COMPUTER SYSTEM WITH THE DISPLAY

(71) Applicant: HAI-QING ZHOU, Shenzhen City (CN)

(72) Inventor: HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/455,266

(22) Filed: Apr. 25, 2012

(30) Foreign Application Priority Data
Dec. 27, 2011 (CN) 201110443671.1

(51) Int. Cl. H01R 13/66; G06F 1/16

(52) U.S. Cl. 439/620.15; 361/679.21

(57) ABSTRACT

A display includes a body, a first video graphics array (VGA) connector, and a light-emitting diode (LED). The first VGA connector is connected to a second VGA connector mounted on a motherboard. When the first VGA connector is connected to the second VGA connector, the signal pins of the first VGA connector are connected to the signal pins of the second VGA connector correspondingly. In addition, a first idle pin of the first VGA connector is connected to a second idle pin of the second VGA connector which is connected to a 5 volt standby power supply of the motherboard. An anode of the light-emitting diode is connected to the first idle pin. A cathode of the light-emitting diode is grounded.

### BACKGROUND

1. Technical Field

The present disclosure relates to displays, and particularly to a display which has an illumination function.

2. Description of Related Art

To prevent eye strain when using a computer display in a darkened room, a reading lamp is sometimes used. If the reading lamp is a desktop lamp, it can take up valuable real estate on the desk. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a display connected with a motherboard.

FIG. 2 is a schematic diagram of a video graphics array (VGA) connector of the motherboard of FIG. 1.

FIG. 3 is a circuit diagram of the display of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

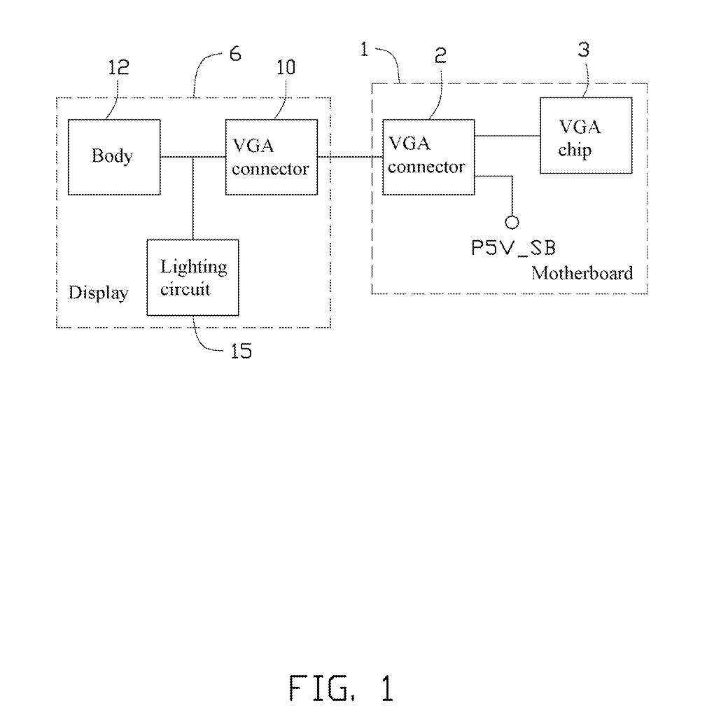

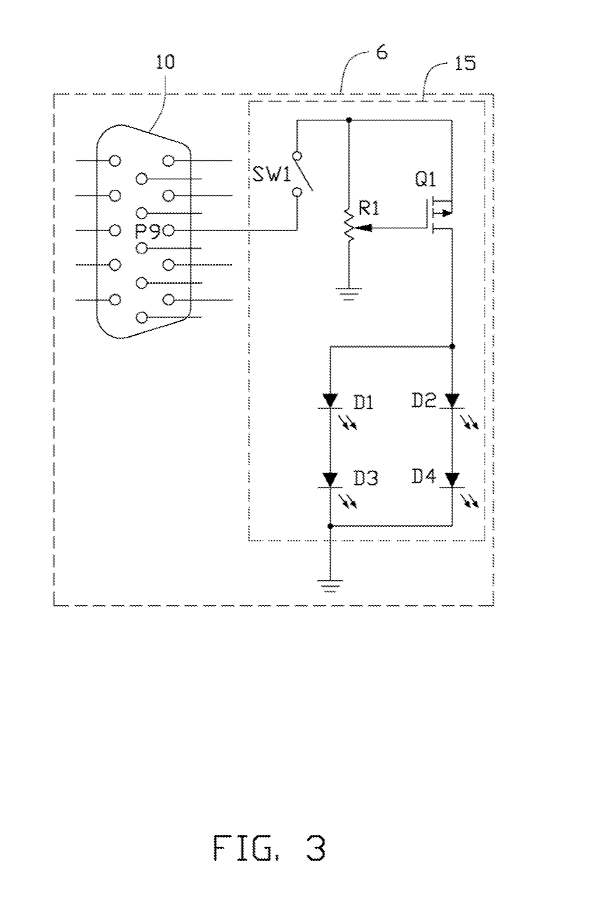

FIGS. 1 and 3, show an exemplary embodiment of a display 6 including a body 12, a video graphics array (VGA) connector 10 mounted on the body 12, and a lighting circuit 15. The lighting circuit 15 includes four light-emitting diodes (LEDs) D1, D2, D3, and D4, a variable resistor R1, a p-channel metal-oxide semiconductor field-effect transistor (MOSFET) Q1, and a switch SW1.

The LEDs D1, D2, D3, and D4 are mounted on a frame of the body 12, and exposed out of the body 12. The body 12 receives power through a power plug. The body 12 is further connected to a VGA connector 2 of a motherboard 1 through the VGA connector 10 for displaying video signals from a VGA chip 3 of the motherboard 1.

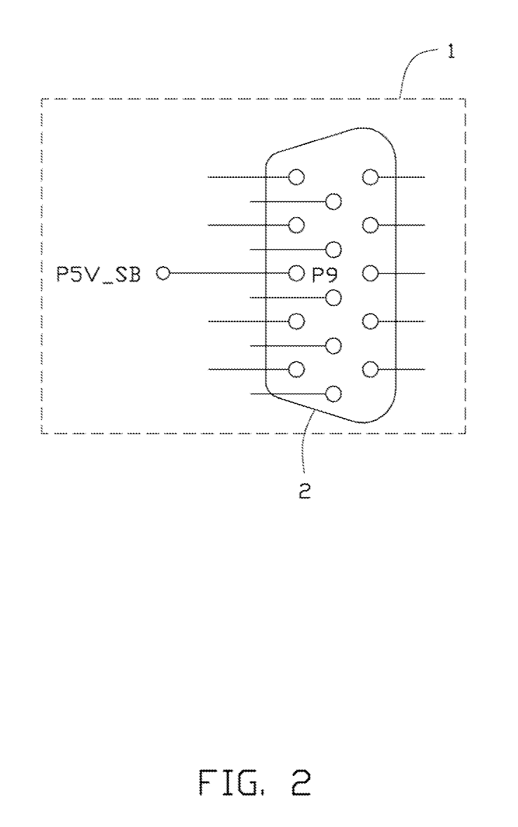

FIG. 2, shows each of the VGA connectors 10 and 2 includes fifteen pins P1-P15 (only pin P9 is labeled in FIG. 2). The pin P1 is a red signal pin. The pin P2 is a green signal pin. The pin P3 is a blue signal pin. The pin P4 is a first address pin. The pin P5 is a self test pin. The pin P6 is a red ground pin. The pin P7 is a green ground pin. The pin P8 is a blue ground pin. The pin P9 is an idle pin. The pin P10 is a digital ground pin. The pin P11 is a second address pin. The pin P12 is a third address pin. The pin P13 is a first synchronism pin. The pin P14 is a second synchronism pin. The pin P15 is a fourth address pin. The pins P1-P8 and P10-P15 of the VGA connector 10 are connected to a display circuit inside the body 12 to transmit video signals to the display circuit. The pins P1-P8 and P10-P15 of the VGA connector 2 is connected to the video chip 3 to receive video signals.

Referring to FIG. 3, the pin P9 of the VGA connector 2 is connected to a 5 volt (V) standby power supply P5V_SB on the motherboard 1. The pin P9 of the VGA connector 10 is connected to a first terminal of the switch SW1. A second terminal of the switch SW1 is connected to a first terminal of the variable resistor R1 and a source of the MOSFET Q1. A second terminal of the variable resistor R1 is grounded. A gate of the MOSFET Q1 is connected to a sliding terminal of the variable resistor R1. A drain of the MOSFET Q1 is connected to anodes of the LEDs D1 and D2. A cathode of the LED D1 is connected to an anode of the LED D3. A cathode of the LED D2 is connected to an anode of the LED D4. Cathodes of the LEDs D3 and D4 are grounded.

When the motherboard 1 is powered on or not powered on, the 5V standby power supply 5V_SB is outputted. When the VGA connector 10 of the display 6 is connected to the VGA connector 2 on the motherboard 1 and the switch SW1 is turned on, the pin P9 of the VGA connector 10 receives the 5V standby power supply 5V_SB through the pin P9 of the VGA connector 2 from the motherboard 1. In addition, a voltage on the gate of the MOSFET Q1 is less than 5V, namely the voltage on the gate of the MOSFET Q1 is less than the voltage on the source of the MOSFET Q1, such that the MOSFET Q1 is turned on. As a result, the 5V standby power supply 5V_SB is applied to the LEDs D1, D2, D3, and D4 through the MOSFET Q1. The LEDs D1, D2, D3, and D4 are activated to emit light.

Moreover, when the sliding terminal of the variable resistor R1 is moved, a voltage difference Vgs on the gate and the source of the MOSFET Q1 changes, and the current flowing through the source of the MOSFET Q1 changes. As a result, the brightness of the LEDs D1, D2, D3, and D4 can be adjustable. When the switch SW1 is turned off, the LEDs D1, D2, D3, and D4 are deactivated.

In the embodiment, the MOSFET Q1 can be replaced by a pnp type transistor. A base of the pnp type transistor corresponds to the gate of the MOSFET Q1. An emitter of the pnp type transistor corresponds to the source of the MOSFET Q1. A collector of the pnp type transistor corresponds to the drain of the MOSFET Q1. Moreover, in the embodiment, the MOSFET Q1 and the variable resistor R1 forms a current adjusting circuit. In other embodiments, the MOSFET Q1 and the variable resistor R1 can be replaced by other current adjusting circuits which can adjust current flowing through the LEDs D1, D2, D3, and D4. In addition, if the brightness of the LEDs D1, D2, D3, and D4 does not need to be adjusted, the current adjusting circuit can be canceled to save cost.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A display, comprising:
a body;
a first video graphics array (VGA) connector to be connected to a second VGA connector of a motherboard, and comprising a plurality of signal pins and a first idle pin, wherein when the first VGA connector is connected to the second VGA connector, the signal pins of the first VGA connector are connected to signal pins of the second VGA connector correspondingly, and the first idle pin is connected to a second idle pin of the second VGA connector which is connected to a 5 volt standby power supply of the motherboard; and
a light-emitting diode mounted on the body, wherein an anode of the light-emitting diode is connected to the first idle pin, a cathode of the light-emitting diode is grounded.

2. The display of claim 1, further comprising a current adjusting circuit, wherein the current adjusting circuit is connected between the first idle pin and the anode of the light-emitting diode for adjusting current flowing through the light-emitting diode.

3. The display of claim 2, wherein the current adjusting circuit comprises a p-channel metal-oxide semiconductor field-effect transistor (PMOSFET) and a variable resistor, a first terminal of the variable resistor is connected to the first idle pin, a second terminal of the variable resistor is grounded, a sliding terminal of the variable resistor is connected to a gate of the PMOSFET, a source of the PMOSFET is connected to the first idle pin, a drain of the PMOSFET is connected to the anode of the light-emitting diode.

4. The display of claim 3, further comprising a switch connected between the first terminal of the variable resistor and the first idle pin.

5. The display of claim 1, further comprising a switch, wherein the switch is connected between the anode of the light-emitting diode and the first idle pin.

6. A computer system, comprising:
a display comprising a body and a first video graphics array (VGA) connector, the first VGA connector comprising a plurality of signal pins and a first idle pin;
a light-emitting diode mounted on the body, wherein an anode of the light-emitting diode is connected to the first idle pin, a cathode of the light-emitting diode is grounded; and
a motherboard comprising a second VGA connector, wherein the second VGA connector comprises a plurality of signal pins connected to a video chip on the motherboard and a second idle pin connected to a 5 volt (V) standby power supply on the motherboard, when the first VGA connector is connected to the second VGA connector, the signal pins of the first VGA connector are connected to the signal pins of the second VGA connector correspondingly, and the first idle pin is connected to the second idle pin.

7. The computer system of claim 6, further comprising a current adjusting circuit, wherein the current adjusting circuit is connected between the first idle pin and the anode of the light-emitting diode for adjusting current flowing through the light-emitting diode.

8. The computer system of claim 7, wherein the current adjusting circuit comprises a p-channel metal-oxide semiconductor field-effect transistor (PMOSFET) and a variable resistor, a first terminal of the variable resistor is connected to the first idle pin, a second terminal of the variable resistor is grounded, a sliding terminal of the variable resistor is connected to a gate of the PMOSFET, a source of the PMOSFET is connected to the first idle pin, a drain of the PMOSFET is connected to the anode of the light-emitting diode.

9. The computer system of claim 8, further comprising a switch connected between the first terminal of the variable resistor and the first idle pin.

10. The computer system of claim 7, further comprising a switch, wherein the switch is connected between the anode of the light-emitting diode and the first idle pin.
